(19) United States
(12) Patent Application Publication
(10) Pub. No.: US 2014/0163929 A1
(43) Pub. Date: Jun. 12, 2014

(54) Pipe Modelling System and Method

(71) Applicant: PINE RICH HOLDINGS CORP., Coquitlam (CA)

(72) Inventors: Michael Richter, Coquitlam (CA); Ben James Cornelius, Vancouver (CA)

(73) Assignee: PINE RICH HOLDINGS CORP., Coquitlam (CA)

(21) Appl. No.: 13/711,609

(22) Filed: Dec. 11, 2012

(30) Foreign Application Priority Data
Dec. 7, 2012 (CA) 2798603

(51) Int. Cl. G06F 17/50

(52) U.S. Cl. CPC G06F 17/50
USPC 703/1

(57) ABSTRACT

A pipe modelling system is provided that includes a series of components. Each of the series of components has an elongate body which has an axis, a first end and a second end. Means are provided for detachably coupling one of the series of components to another of the series of components in end to end relation to form a desired pipe layout. Each of the series of components has at least one identifying marker representing at least one measurable feature of the component.

### FIELD

The invention relates to a pipe modelling system and method that is suitable for use as in designing piping layouts for acquiring accurate data for manufacturing pipe to the specific requirements.

### BACKGROUND

Pipe layouts are required in a variety of applications such as exhaust systems, oil and gas industrial work, food processing and construction industries. It's not always practical or possible to bring the application to the site of the fabrication. Previously, piping layouts were configured by using CAD (computer aided design) programs that produced three dimensional views of pipe layouts. CAD programs are well known in the art. These types of programs require substantial knowledge and cost to operate and render accurate views. Furthermore, calculating and recording the appropriate data can be vulnerable to human error rendering incorrect or incomplete calculations for the purpose of manufacturing specific pipes for the desired configuration. The cost in time and money related to incorrect manufacturing of pipes is substantial.

### SUMMARY

What is required is a modelling system that is easier to use in designing and accurately configuring designing piping layouts to acquiring accurate data for manufacturing pipe to specific requirements.

According to the present invention there is provided a pipe modelling system which includes a series of components. Each of the series of components has a body which has an axis, a first end and a second end. Means are provided for detachably coupling one of the series of components to another of the series of components in end to end relation to form a desired pipe layout. Each of the series of components has at least one identifying marker representing at least one measurable feature of the component.

According to another aspect of the invention, a male member is provided on the first end of the body and a female member is provided on the second end of the body. The male member is dimension to fit within the female member at the first end of an adjacent one body to detachably coupling one component to another in end to end relation.

According to another aspect of the invention, a slotted channel provided on the first end the body. Slotted channel has an inwardly extending retaining lip on opposed sides. A protrusion is provided on the second end of the body. The protrusion being dimension to fit within the slotted channel at the first end of an adjacent one body and is retained in the slotted channel by the retaining lip for detachably coupling one components to another in end to end relation.

According to another aspect of the invention, there is also provided a securing member for securing one of the components to an object such as a manifold. The securing member has a body with a first end, and a second end. Means are provided for detachably coupling the second end to one of the series of components. A circumferential flange is provided with spaced apertures for receiving threaded fasteners to fasten the securing member to the object.

In another aspect of the invention, the identifying marker is colour that is applied to all or a portion of an external surface of the body

In another aspect of the invention, the identifying marker is an electronically readable identification or a two dimensional code.

According to another aspect of the present invention, one of the series of components is a rotator component. The rotator component is positioned between two other components to allow for one of the components to be rotated relative to the other to change the angle of the desired pipe layout by measurable degrees.

In another aspect of the invention, the pipe modelling system includes a web or software application for entering data representing the one identifying marker and processing the data to display a virtual three dimensional representation of the desired piping layout

According to another aspect of the present invention there is provided a method of pipe modelling which includes the step of providing a series of components. A selected number of the components are then arranged and coupled in end to end relation to form a desired pipe layout. Once the desired layout has been achieved, then one identifying marker representing at least one measurable feature on each of the series of components is read and that data from one or more identifying marker representing at least one measurable feature is recorded.

According to another aspect of the present invention, the recorded data representing the one identifying marker is entered in to a web application or software application which processes the data to display a virtual three dimensional representation of the desired piping layout.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is an exploded view of the pipe modelling system of the present invention.

FIG. 2 is an assembled side elevation view of the pipe modelling system of the pipe modelling system illustrated in FIG. 1.

FIG. 3 is a front perspective view of one of the components.

FIG. 4 is a back perspective view of the component illustrated in FIG. 3.

FIG. 5 is a top view of the component illustrated in FIG. 3.

FIG. 6 is a side elevation view of the component illustrated in FIG. 3.

FIG. 7 is a first end elevation view of the component illustrated in FIG. 3.

FIG. 8 is a second end elevation view of the component illustrated in FIG. 3

FIG. 9 is a side elevation view of the male member and female member about to engage.

FIG. 10 is side elevation view in section of the male and female members engaged.

FIG. 11 through 16 are front perspective views of various securing component.

FIG. 17 is a front perspective view of the securing component.

FIG. 18 is a side elevation view of the securing component.

FIG. 19 is a perspective view of a ball connector component.

FIG. 20 is a perspective view of a rotator component.

FIG. 21 is an exploded view of the rotator component.

FIG. 22 is a side elevation view in section, of the rotator component.

FIG. 23 is an end view of the male engaging profile.

FIG. 24 is an end view of the female engaging profile.

FIG. 25 is a representation of an interface for a web application or software application.

FIG. 26 is a flow chart illustrating the method of using the pipe modelling system.

FIG. 27 is a flow chart illustrating an alternative method of using the pipe modelling system featuring software.

### DETAILED DESCRIPTION

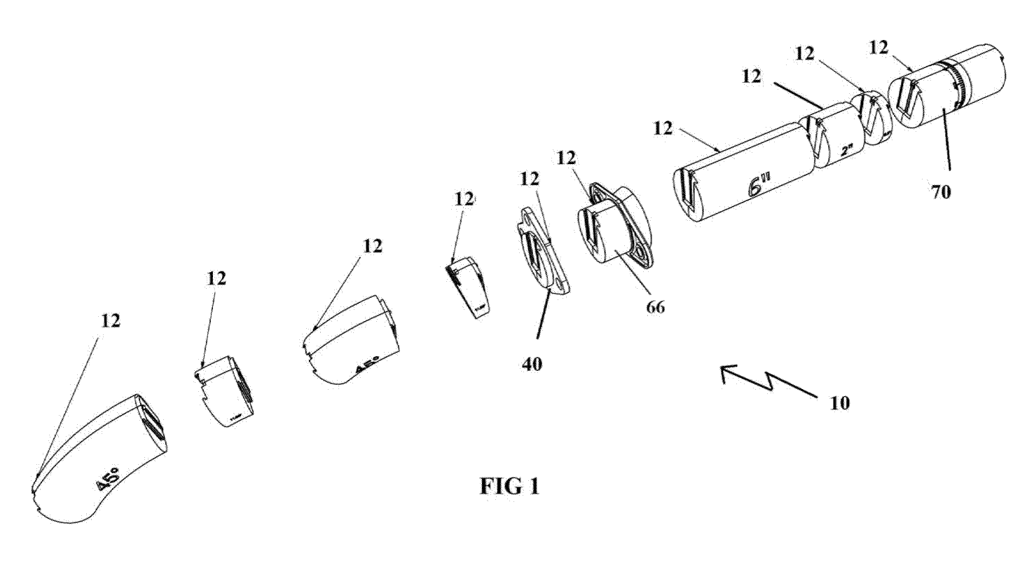

A Pipe Modelling System generally identified by reference numeral 10, will now be described with reference to FIG. 1 through FIG. 27.

### Structure and Relationship of Parts:

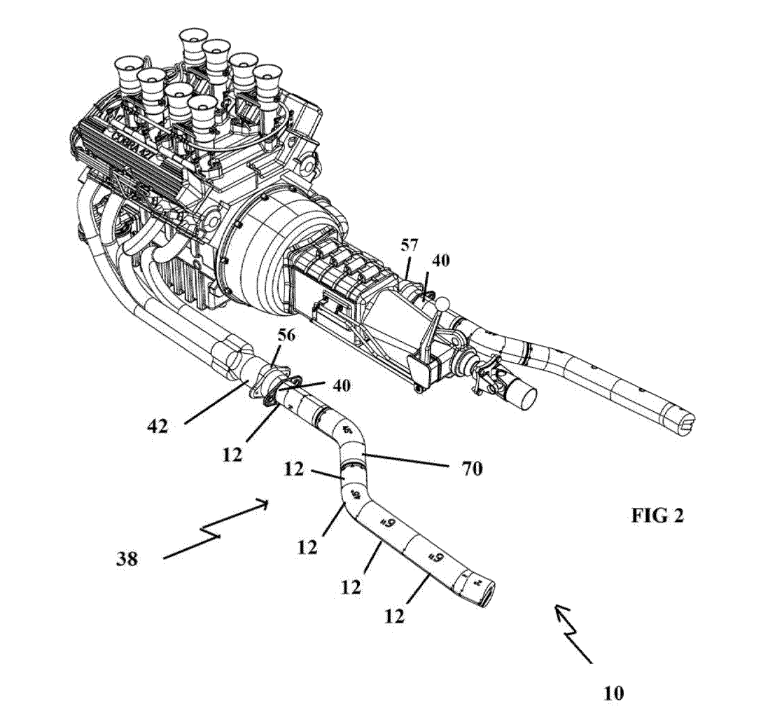

Referring to FIG. 1, there is illustrated the pipe modelling system generally referenced by numeral 10. The pipe modelling system 10 includes a series of components 12. Referring to FIG. 2, each of the components 12 is capable of being detachably coupled to another of the series of components 12 in end to end relation.

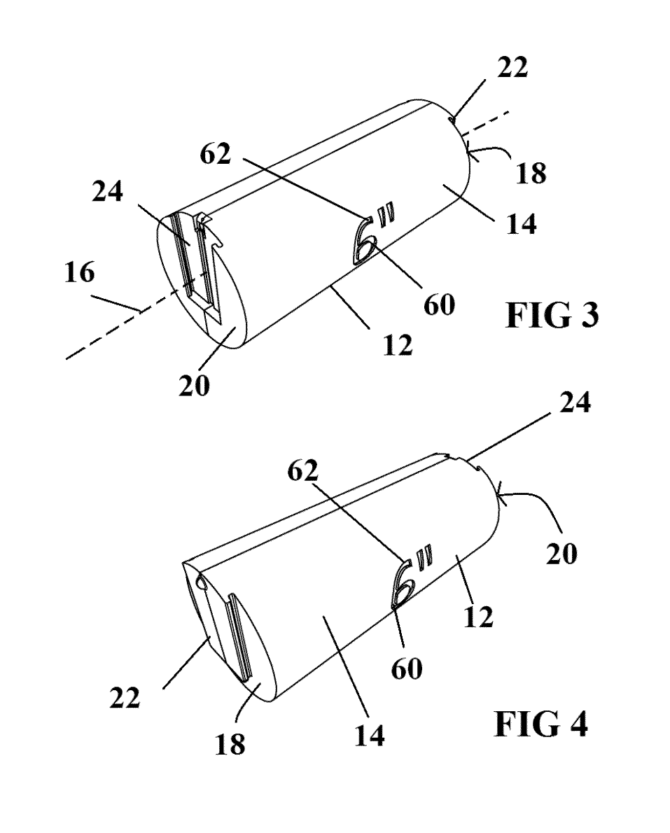

Referring to FIG. 3 through FIG. 6, each component has a tubular body 14 with an axis 16, and a first end 18 and a second end 20. A male member 22 is provided on the first end 18 of each body 14 and a female member 24 is provided on the second end 20 of each body 14. The male member 22 is dimension to fit within the female member 24 of an adjacent body 14 as illustrated in FIG. 10.

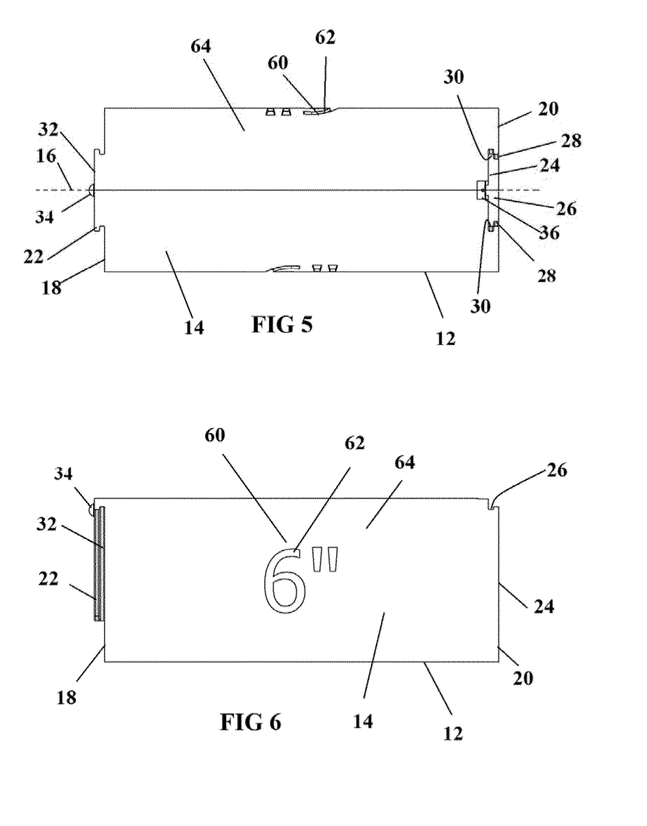

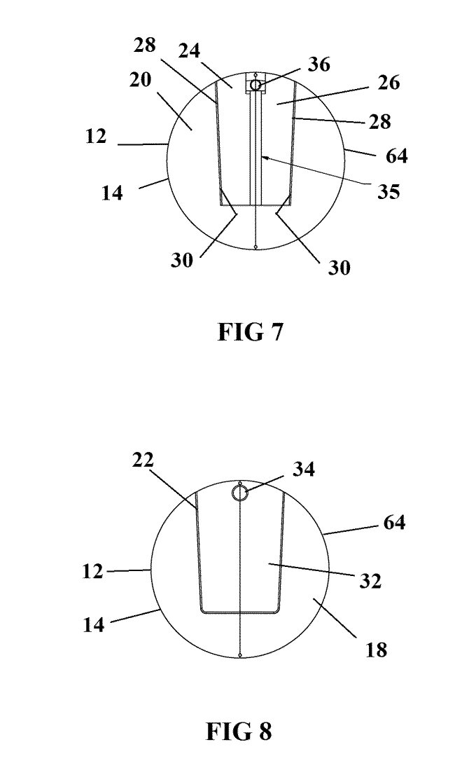

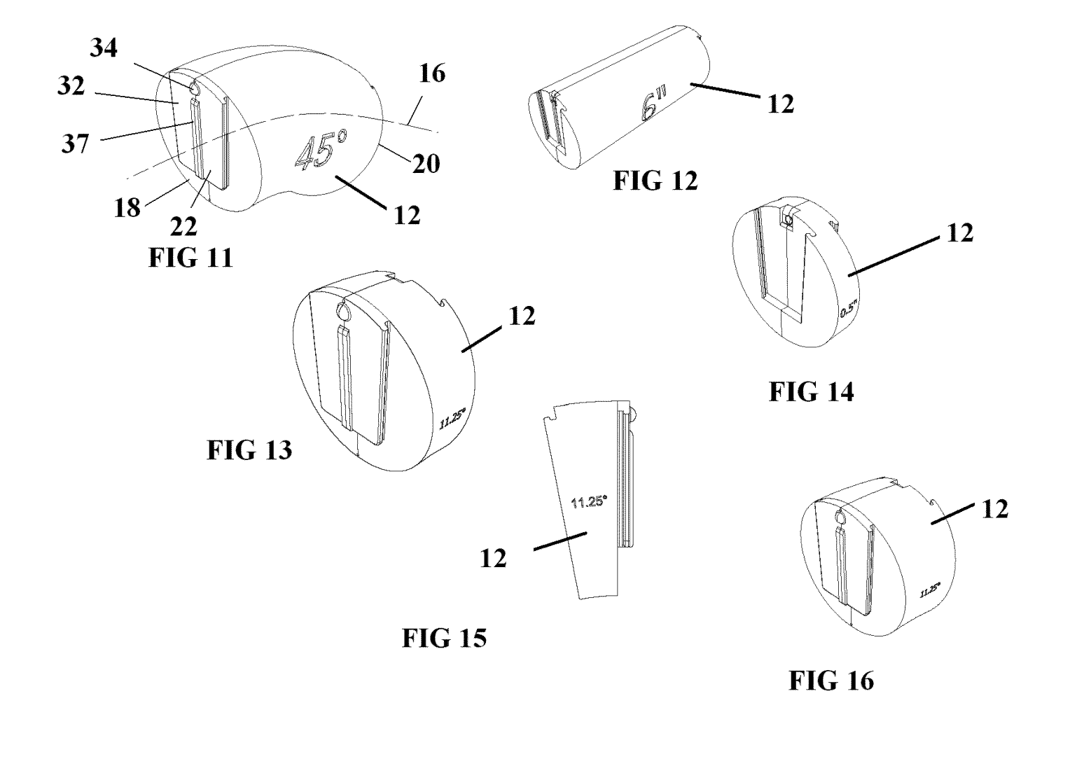

Referring to FIG. 5, FIG. 6 and FIG. 7, in the illustrated embodiment, the female member 24 is a slotted channel 26. The slotted channel 26 has an inwardly extending retaining lip 28 that extends along opposed sides 30. Referring to FIG. 5, FIG. 6 and FIG. 8, the male member 22 is a protrusion 32. The protrusion 32 is dimension to fit within the slotted channel 26 at the first end 18 of an adjacent body 14 and retained within the slotted channel 26 by the retaining lip 28 as illustrated in FIG. 10. Referring to FIG. 10 again, a retaining bump 34 is provided on the protrusion 32 which contacts with a corresponding indent 36 in the slotted channel 26 to maintain the protrusion 32 within the slotted channel 26. Retaining bump 34 can be overcome with manual pressure if the assembled components 12 need to be detached from each other. Referring to FIG. 7, a central guide groove 35 is provided in slotted channel 26 to guide retaining bump 34 to the indent 36. Referring to FIG. 11, a central raised guide rail 37 is provided on male protrusion 32 which is dimensioned to ride in central guide groove 35. It will be appreciated that alternatively, the male protrusion 32 could carry the indent 36 and groove guide 35 while the slotted channel 26 could feature the corresponding bump 34 and guide rail 37. It will also be appreciate that other types of male and female members can be used to connect one component 12 to another as illustrated in FIG. 2. The present description is used as it prevents unintentional rotation of the components 12 during a design phase. Furthermore, when interchanging components 12 during the mock up design phase, the orientation of other components 12 in the subsequently connected design 34 are not affected. One component 12 can simply be slid out of engagement from another component 12 without changing the orientation of adjacent components 12.

Referring to FIGS. 11 through 16, the components 12 come in a variety of lengths, diameters, and sizes, and can be straight, or can be configured in various bend formations and curvatures. Each has an axis 16 as illustrated in FIG. 3 an FIG. 11. Axis 16 can be straight as in FIG. 3 or curved as in FIG. 11. Referring to FIG. 4, while the illustrated embodiment shows tubular components 12, it will be appreciated that the circumferential shape of the component bodies 14 could be square, rectangular or oblong depending on the application. Other configurations of components 12 in addition to those illustrated can be provided including “c” or “u” bend components, or even “s” shaped or “Y” and “T” splitter components. In the present embodiment, illustrated components 12 are on a 1:1 ratio in scale to the pipe to be fabricated; however there are applications where the scale may differ. Components 12 can be manufactured of lightweight plastic such as ABF, so that they are easy and inexpensive to make, light enough for transporting, and reusable. Components 12 can then easily be assembled into a mock up of a desired pipe run 38 as illustrated in FIG. 2.

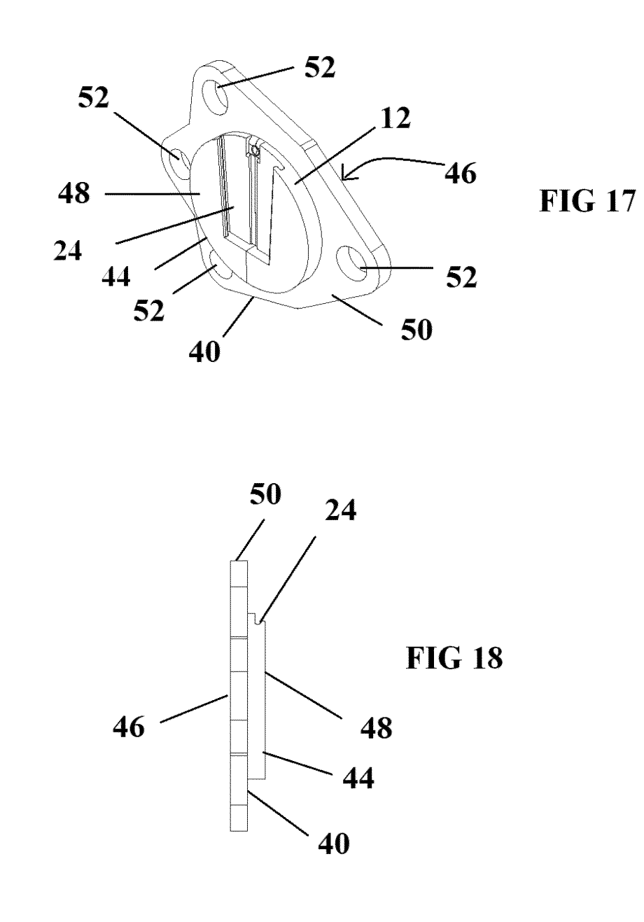

Referring to FIG. 2, a securing member 40 is provided for securing one of the components 12 to an object such as a manifold exhaust 42. Referring to FIG. 17 and FIG. 18, each securing member 40 has a body 44 with a first end 46 and a second end 48. In the illustrated embodiment 10, the body 44 has a circumferential flange 50 with spaced apertures 52 for receiving threaded fasteners 54 to fasten the securing member 40 to the manifold 42 illustrated in FIG. 2, or other similar object. Circumvention flange 50 can rotate around the body 44 for alignment with manifold 42. If the securing member 40 is being used to secure the first end 18 of one of the components 12 to an object such a manifold 42 illustrated in FIG. 2, then a female engagement member 24 is provided on the second end 48 of the body 44 of the securing member 40 as illustrated in FIG. 17. If the securing member 40 is being used to secure the second end 30 of a component 12, then a male engagement member 22 is provided on the second end 48 of the body 44 of the securing member 40. Referring FIG. 2, securing members 40 can be used at the start 56 or the end 57 of a pipe run 38 to anchor it.

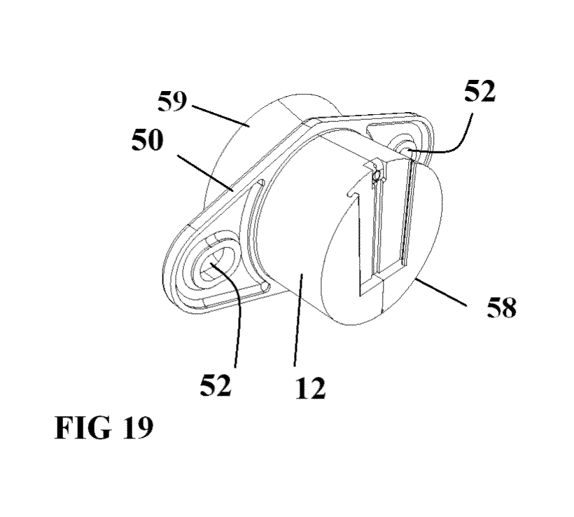

Referring to FIG. 19, there is provided a ball valve securing member 58 which is similar to securing member 40 illustrated in FIG. 18 however ball valve securing member 58 has a flared end 59.

Referring to FIG. 6, each component 12 is provided with one or more identifying markers 60. Each identifying marker 60 represents one or more features of the component 12 such its use or style, or a measurable value such as its length, diameter, circumference, angle and curvature. In the illustrated embodiment 10 shown in FIG. 2, the identifying marker 60 is code comprised of alphanumeric characters 62 which are displayed and visually accessible on an external surface 64 of the body 14 of the component 12 as illustrated in FIG. 6.

It will be appreciated that other types of identifying markers 60 could also be used such as a two dimensional code, or a colour that is applied to the external surface 64 of the body 14. It will also be appreciate that electronically readable identification code could be provided on or in the body 14 of the component 12. A scanner or device capable of scanning (not illustrated) the code would be used in conjunction with the electronically readable code. It will also be appreciated that more than one identifying marker 60 can be placed each component 12 depending on the features or values required to be identified and recorded.

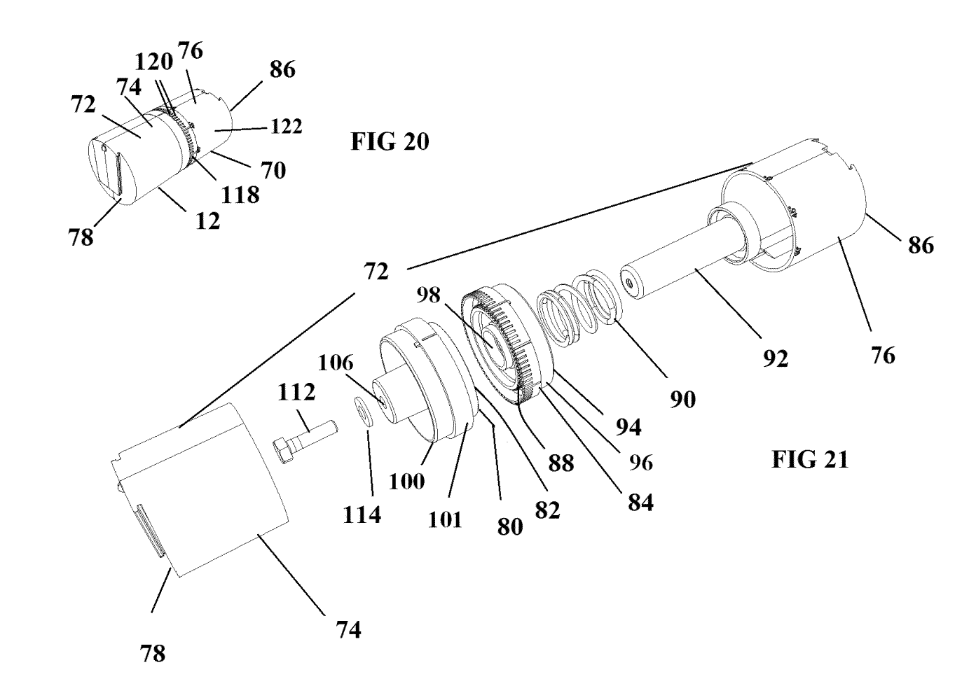

Referring to FIG. 20, a rotator component 70 is also provided. Referring to FIG. 2, the rotator component 70 can be positioned between two components 12 to allow for one of the components 12 to be rotationally moved relative to the other 12 so as to change the angle of the desired pipe layout 38 by measurable degrees. Referring to FIG. 21, the rotational component 70 has body 72 which has a first portion 74 and a second portion 76. The first portion 74 has a first end 78 and a second end 80. The second end 80 has a first engagement profile 82. The second portion 76 also has a first end 84 and a second end 86. The first end 84 has a second engagement profile 88.

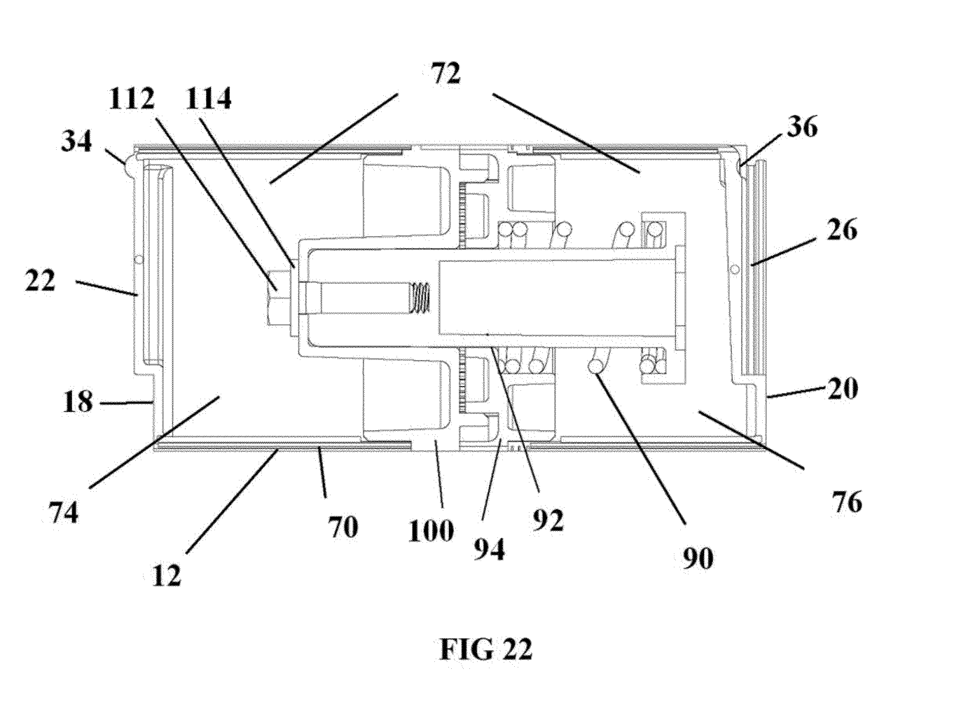

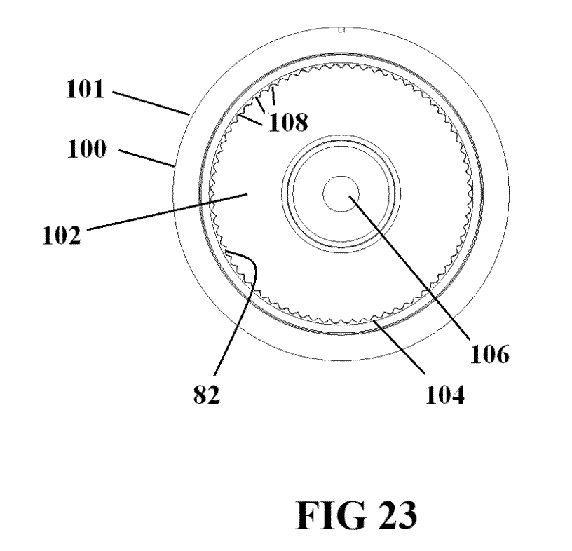

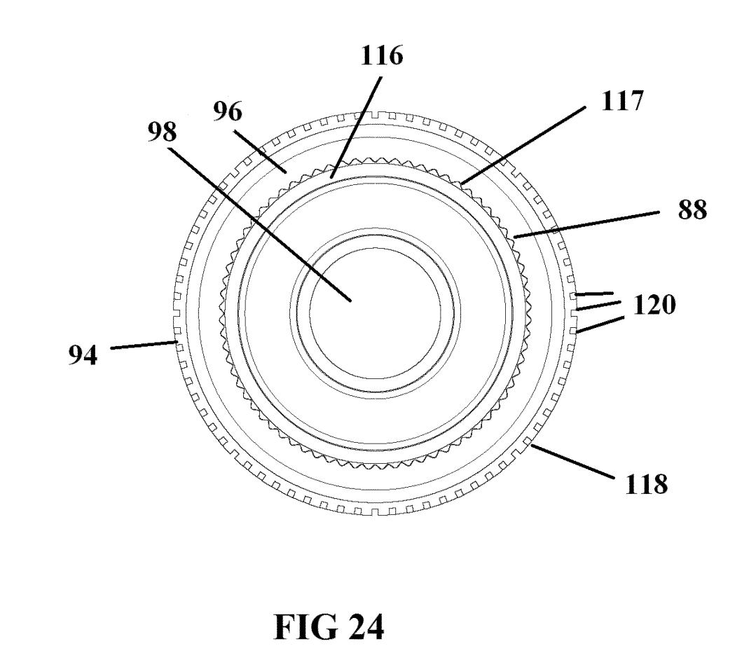

Referring to FIG. 22, a compression spring 90 is provided for maintaining the first engagement profile 82 illustrated in FIG. 23 in contact with the second engagement profile 88 illustrated in FIG. 24 until an applied manual force overcomes the force of the compression spring 90.

Referring to FIG. 21 and FIG. 22, in the illustrated embodiment, second portion 76 has a rotator shaft 92 on which compression spring 90 is placed. Referring to FIG. 21, second engagement profile 88 is provided on a male rotator 94. Male rotator 94 has an annular body 96 with a central aperture 98. Annular body 96 slides onto the rotator shaft 92 with the compression spring 90 deposed between the second end 86 of the second portion 76 and the annular body 96 which forms the first end 84 of the second portion 76 as illustrated in FIG. 21.

Referring to FIG. 21, second end 80 of first portion 74 has a female rotator 100. Referring to FIG. 23, female rotator 100 is an annular body 101 with a receiving bore 102. Receiving bore 102 has an interior wall 104 which surrounds a central aperture 106. The interior wall 104 of the receiving bore 102 is provided with 360 spaced indentations 108 that are directed inwardly which represent the first engagement profile 82. Central aperture 106 receives a securing fastener 112 for fastening to a rotator shaft 94 as illustrated in FIG. 21. A washer 114 is also provided.

Referring again to FIG. 24, a circumferential wall 116 extends around the central aperture 98 of the annular body 96 of male rotator 94. The circumferential wall 116 is provided with 360 spaced teeth 117 that are directed outwardly representing the second engagement profile 88. The teeth 117 of the circumferential wall 116 engage with the indentations 108 on the interior wall 104 when the male rotator 94 is seated in the female rotator 100 as illustrated in FIG. 22. They are disengaged temporarily when the compression spring 90 is overcome manually to rotate the first portion 74 of the rotator component 70 relative to the second portion 76 and then are reseated when the manual force is released. Referring to FIG. 20, a degree indictor 118 with incremental degree measurements 120 is visibly accessibly on an exterior surface 122.

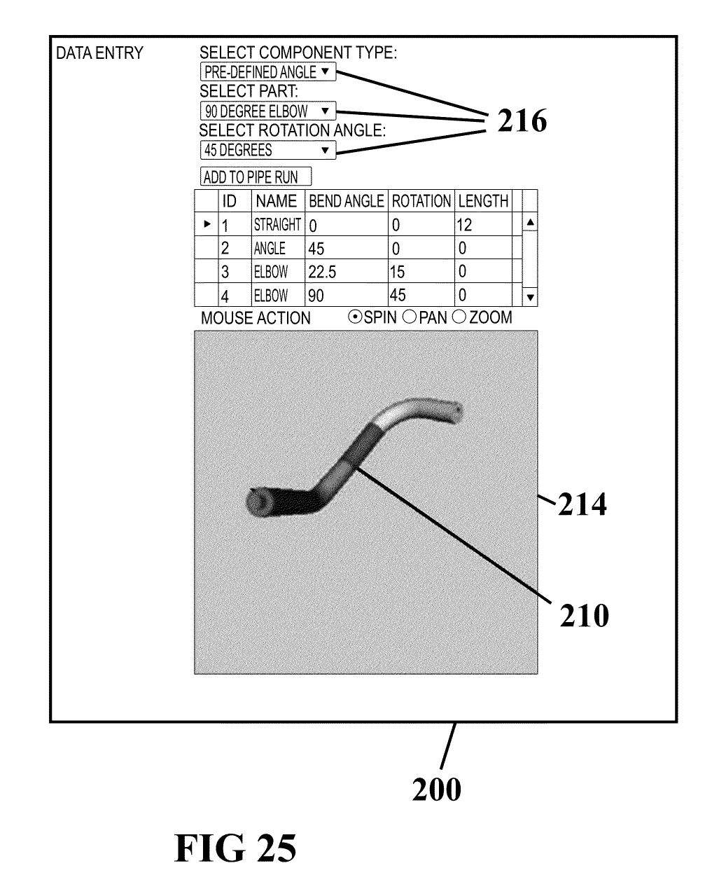

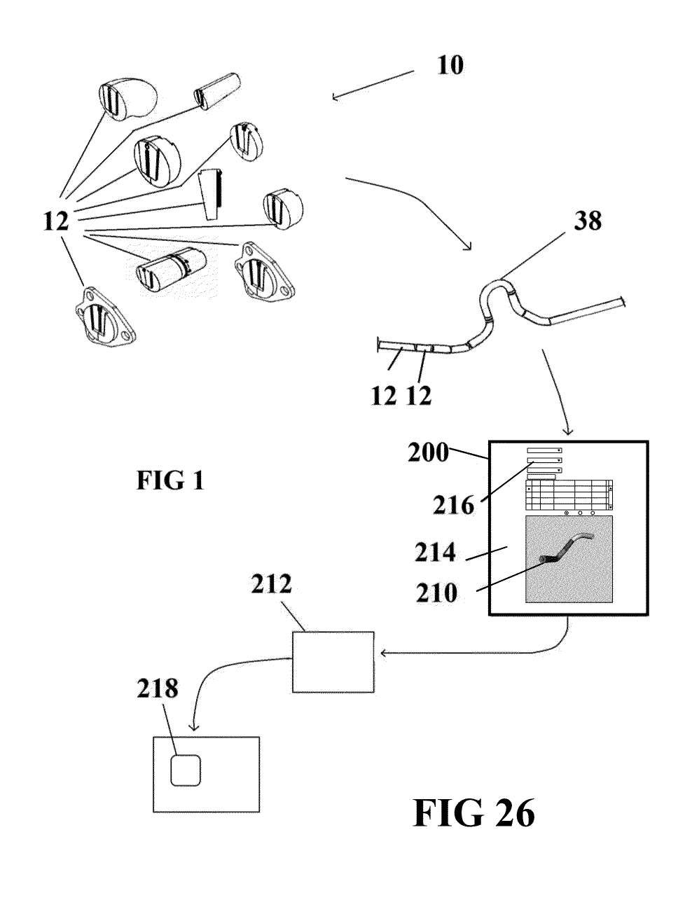

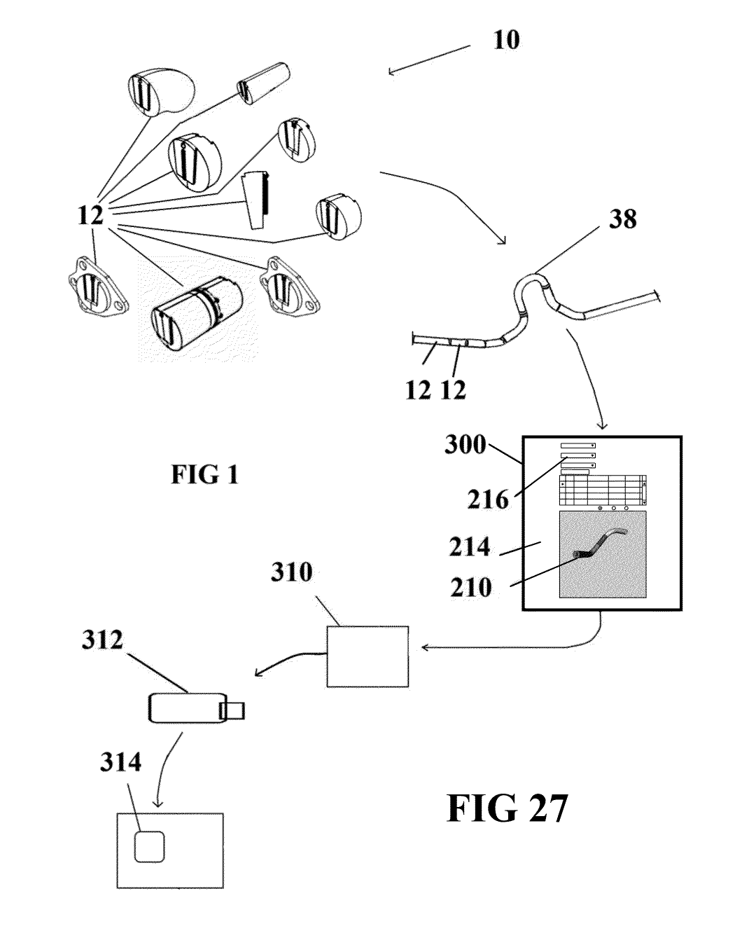

Referring to FIG. 26, a web application generally referenced by numeral 200 is provided for entering data collected from the one identifying marker 60 illustrated in FIG. 3 of each component 12, and processing the data to display a virtual three dimensional representation 210 of the desired piping layout 38 illustrated in FIG. 2. Web application 200 is accessible through a device such as a computer 212, tablet, or cellular phone that is connected to the internet. Once all the data has been collected, a user can enter the collected data into the web application 200. Referring to FIG. 25, web application 200 includes has a screen display 214 with several entry fields 216 where data can be entered. The manner in which data is entered is known in the art of web applications and can include numerical entries, radio buttons and drop down menus among other methods. In the present application, drop down menus are used. The entry fields 216 include collection of data entries with respect to component type, selection of part and section of rotation angle.

Referring to FIG. 27, it will be appreciated that a software application generally referenced by numeral 300 could also be used in instances where internet resources are not accessible or desirable. Software application 300 or program could be run on a computer laptop 310, cellular phone, tablet, scanner or similar device with processing capabilities. The software application could record and retain data and could later transmit that data remotely when internet access is available. Alternatively, it could allow for the electronic data to be transferred to storage devices such as USB flash drives 312 for transport to manufacturing facilities 314.

Electronic data about the mock up of the desired pipe run 38 is used to manufacture specific pipe as will herein after be described.

### Operation:

The use and operation of pipe modelling system 10 will now be described with reference to FIG. 1 through FIG. 27.

Referring to FIG. 2, the use and operation of the pipe modeling system 10 includes the initial step of providing the series of components 12 as described above. Any number and combination of components 12 can be provided. The desired configuration 38 can begin with a securing member 40 at the start 56 which may be used to secure it to an existing piping structure such a manifold 42. Then any of the components 12 can be selected and secured the securing member 40. Components 12 can be subsequently to each other in end to end fashion until a desired arrangement 38 is established. A securing member 40 can be used to end the desired pipe run 38 and secure it to an existing pipe arrangement such as manifold 42

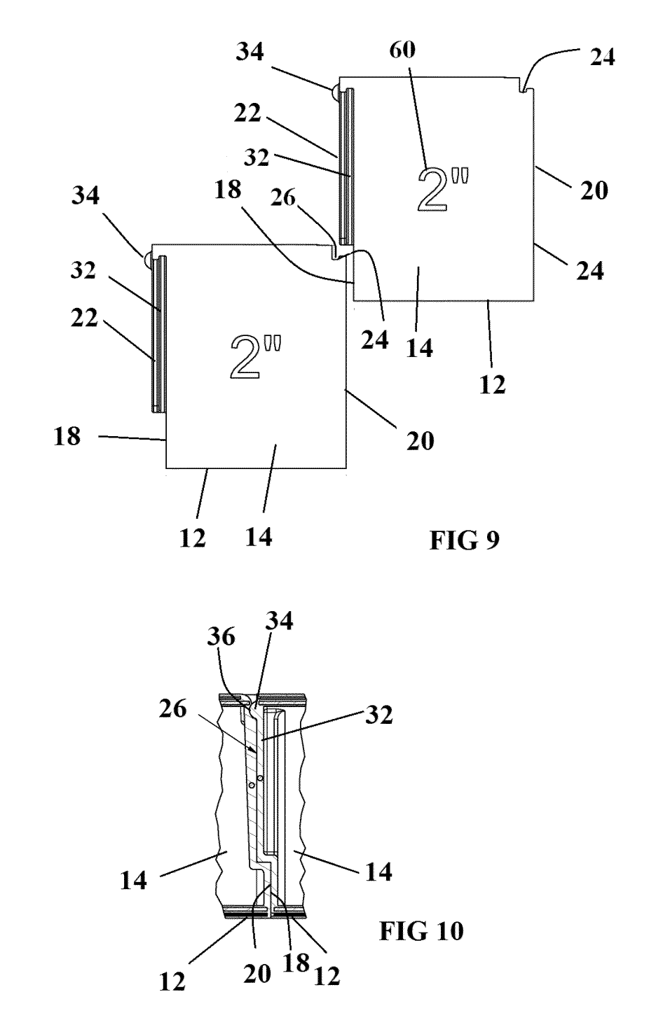

Referring to FIG. 9 and FIG. 10, in order to secure the components 12 together in to end fashion, a user sides the protrusion 32 on the second end 20 of the body 14 of one component 12 into the slotted channel 26 at the first end 18 of the body 14 of an adjacent component 12. Protrusion 32 should be pushed into slotted channel 26 far enough that retaining bump 34 contacts with indent 36 in the slotted channel 26 to maintain protrusion 32 within the slotted channel 26 as illustrated in FIG. 10. Retaining bump 34 can be overcome with manual pressure if the components 12 need to be detached from each other. Referring to FIG. 2, components 12 can be attached and detached from each other, and interchanged as necessary until a desired configuration of pipe run 38 is achieved. If the installation requires that a component 12 at the end 57 of a pipe run 38 be secured to another object such as a manifold 42, illustrated in FIG. 2, then securing member 40 can be used to do so. The end result is a real life mock up representing what a piping layout 38 would look like if it were installed.

Referring to FIG. 2, once the desired configuration of pipe run 38 is completed with the components 12 secured together, and then the identifying marker or markers 60 representing features on each of the series of pipe components 12 as illustrated in FIG. 6 can be read and recorded as data.

Referring to FIG. 25, data can be recorded or entered into a web application 200 via the entry fields 216 where data can be entered. The manner in which data is entered is known in the art of web applications and can include numerical entries, radio buttons and drop down menus among other methods. In the present application, drop down menus are used. In the illustrated embodiment, the entry fields 216 include collection of data entries with respect to component type, selection of part and section of rotation angle.

Referring again to FIG. 26, the web application will then construct a three dimensional model 210 of the pipe run 38 illustrated in FIG. 2, or spool based on the entered collected data to visually confirm that the pipe run 38 is accurate.

Referring to FIG. 26, collected data is then converted into specifically formatted LRA information. Specifically formatted LRA information is eventually transmitted to a production facility 218 where it can be entered into machines that are used for pipe bending. LRA information can be used in CNC (computer numeric control) and manually controlled machines as well as a variety of other pipe fabrication machinery. This will yield specific and accurate pipe or tube as ordered by the customer.

Referring to FIG. 27, a similar process can occur with a software programs application 300. Software program 300 could also be used in instances where internet resources are not accessible. A software application 300 or program could be run on a computer laptop 310, cellular phone, tablet or similar device with processing capabilities. The software application could record and retain data and could later transmit that data remotely when internet access is available. Alternatively, it could allow for the electronic data to be transferred to storage devices such as usb flash drives 312 for transport to manufacturing facilities 314.

### Variations

It will be appreciated that the pipe modelling system 10 is also suitable for use in applications such a manifold and exhaust design, oil and gas applications, plumbing and heating arrangements, and food processing in designing appropriate layouts and acquiring data for manufacturing materials to the specific requirements.

It will be appreciated that the two or more of the components 12 could be packaged and sold together as a kit. The components 12 are intended to be lightweight, resilient, easy and fast to assemble and disassemble and reusable. It will also be appreciated that a kit could further include access to the web application, or a software program and a carrying case to facilitate transport. If the components 12 featured an electronically readable identification code provided on or in the body 14 of the components 12, then the kid could further include a device such as a scanner that is capable of reading the electronically readable identification code.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practised other than as specifically illustrated and described.

What is claimed is:

1. A pipe modelling system comprising;
a series of components, each of the series of components having a body with an axis, a first end and a second end;
means for detachably coupling one of the series of components to another of the series of components in end to end relation to form a desired pipe layout; and
each of the series of components having at least one identifying marker representing at least one feature of the component.

2. The pipe modelling system of claim 1 wherein the means for detachably coupling one of the series of components to another of the series of components in end to end relation is a male member provided on the first end of the body and a female member provided on the second end of the body, the male member of one body being dimension to fit within the female member of at the first end of an adjacent body.

3. The pipe modelling system of claim 2 wherein the female member is a slotted channel having an inwardly extending retaining lip on opposed sides, and the male member is a protrusion, the protrusion being dimension to fit within the slotted channel of an adjacent component and retained in the slotted channel by the retaining lip.

4. The pipe modelling system of claim 1 further including at least one securing member for securing one of the series of components to an object, the securing member having a body with a first end and a second end, means for detachably coupling the second end to one of the series of components, and a circumferential flange with spaced apertures for receiving threaded fasteners to fasten the securing member to the object.

5. The pipe modelling system of claim 1 wherein the at least one identifying marker is colour applied at least a portion of an external surface of the body.

6. The pipe modelling system of claim 1 wherein the at least one identifying marker is a code comprised of alphanumeric characters displayed on an external surface of the body.

7. The pipe modelling system of claim 1 wherein the at least one identifying marker is a two dimensional code applied to an external surface of the body

8. The pipe modelling system of claim 1 wherein the at least one identifying marker is an electronically readable identification code provided on or in the body of the component.

9. The pipe modelling system of claim 1 wherein one or more of the series of components are curved.

10. The pipe modelling system of claim 1 wherein one or more of the series of components are straight.

11. The pipe modelling system of claim 1 wherein at least one of the series of components is a rotator component, the rotator component being positioned between two of the series of components to allow for one of the components to be moved relative to the other for changing the angle of the desired pipe layout by measurable degrees.

12. The pipe modelling system of claim 11 wherein the rotational component has body comprised of a first portion and a second portion, the first portion having a first end and a second end with a first engagement profile, the second portion having a first end and a second end with a second engagement profile, and means for maintaining the first surface engagement profile in contact with the second surface engagement profile until an applied manual force overcomes the force.

13. The pipe modelling system of claim 12 wherein the means for maintaining the first surface engagement profile in contact with the second surface engagement profile is a spring.

14. The pipe modelling system of claim 12 wherein the first engagement profile and the second engagement permit rotation in measurable degree increments.

15. The pipe modelling system of claim 1 further including a web application for entering data representing the at least one identifying marker and processing the data to display a virtual three dimensional representation of the desired piping layout.

16. The pipe modelling system of claim 1 further including a software application for entering data representing the at least one identifying marker and processing the data to display a virtual three dimensional representation of the desired piping layout.

17. A method of pipe modelling comprising the steps of;
providing a series of components, each of the series of components having an elongate body having an axis, a first end and a second end, means for detachably coupling one of the series of components to another of the series of components in end to end relation to form a desired pipe layout, and each of the series of components having at least one identifying marker representing at least one feature of the component;
arranging two or more of the series of components in end to end relation to form a desired pipe layout;
reading the at least one identifying marker representing at least one measurable feature on each of the series of pipe components;
recording data representing the at least one identifying marker representing at least one feature.

18. The method of pipe modelling of claim 17 wherein the recorded data is provided to a web application for processing the data and displaying a virtual three dimensional representation of the desired piping layout.

19. The method of pipe modelling of claim 17 wherein the recorded data is provided to a software application for processing the data and displaying a virtual three dimensional representation of the desired piping layout.
